(19) United States
(12) Patent Application Publication
(10) Pub. No.: US 2012/0066634 A1
(43) Pub. Date: Mar. 15, 2012

(54) BRANDED BROWSER FRAME

(75) Inventors: Jane T. Kim, Seattle, WA (US); Mary-Lynne Williams, Seattle, WA (US); Jess S. Holbrook, Seattle, WA (US); Sarah J. Bowers, Snohomish, WA (US); Warren G. Stevens, Redmond,, WA (US); Mirko Mandic, Seattle, WA (US); Martin J. Hall, Seattle, WA (US); Bruce A. Morgan, Bellevue, WA (US); Israel Hilerio, Kenmore, WA (US); Alexander H. Malek, Seattle, WA (US); Laura J. Gehring, Bellevue, WA (US); Michael J. Ens, Redmond, WA (US); John E. Davis, Renton, WA (US)

(73) Assignee: MICROSOFT CORPORATION, Redmond, WA (US)

(21) Appl. No.: 12/881,420

(22) Filed: Sep. 14, 2010

(51) Int. Cl. G06F 3/048

(52) U.S. Cl. 715/777

(57) ABSTRACT

In at least some embodiments, a web browser user interface is designed to enable site branding and functionality. Specifically, websites can provide content that can be utilized in a control layout area near the top of the web browser user interface to reinforce branding through the use of color and/or a site-provided icon, termed a “favicon” that serves dual roles as a branding instrumentality and a site's home button. Further, in at least some embodiments, branding can be reinforced through the use of a site-associated color that is utilized for rendering one or more web browser navigation controls.

### BACKGROUND

Studies have shown that people tend to want to focus on web site content and not necessarily the capabilities of their web browser when they are conducting browsing activities. Yet, browser designs tend to focus on a user interface that emphasizes the browser's capabilities, thus making it more challenging for a user to focus on a web site's content. Further, recently there has been a move on the part of websites to model their functionality, as perceived by the user, more like a desktop application. In this context, challenges exist to facilitate content presentation that reinforces the notion of a website acting as an application.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In various embodiments, a web browser user interface includes a subset of selected controls distributed along a single line at the top of the web browser user interface. Layouts of the controls can be in a left-to-right or a right-to-left fashion. Specifically, in a left-to-right layout, selected controls meeting certain criteria can appear to the left of other controls. Similarly, in a right-to-left layout, selected controls meeting certain criteria can appear to the right of other controls. In at least some embodiments, at least some of the controls that appear distributed along the single line are controls that are related to navigation of some type. Such controls can include those that enable textual input to be provided by user.

In addition, in at least some embodiments, a control set can be visually treated within the web browser user interface in a manner that places greater emphasis on site content rather than controls.

In at least some embodiments, a web browser user interface is designed to enable site branding and functionality. Specifically, websites can provide content that can be utilized in a control layout area near the top of the web browser user interface to reinforce branding through the use of color and/or a site-provided icon, termed a “favicon,” that serves dual roles as a branding instrumentality and a site's home button. Further, in at least some embodiments, branding can be reinforced through the use of a site-associated color that is utilized for rendering one or more web browser navigation controls.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 illustrates an example web browser in accordance with one or more embodiments.

FIG. 3 illustrates a control layout area in accordance with one or more embodiments.

FIG. 4 illustrates a control layout area in accordance with another embodiment.

FIG. 5 illustrates a control layout area in accordance with another embodiment.

FIG. 6 illustrates a control layout area in accordance with another embodiment.

FIG. 7 illustrates an example web browser in accordance with one or more embodiments.

FIG. 8 illustrates a control layout area in accordance with another embodiment.

FIG. 9 illustrates a control layout area in accordance with another embodiment.

FIG. 10 is a flow diagram that describes steps a method in accordance with one or more embodiments.

FIG. 11 illustrates an example system that can be used to implement one or more embodiments.

### DETAILED DESCRIPTION

### Overview

In various embodiments, a web browser user interface includes a subset of selected controls distributed along a single line at the top of the web browser user interface. Layout of the controls can be in a left-to-right or a right-to-left fashion. Specifically, in a left-to-right layout, selected controls meeting certain criteria can appear to the left of other controls. A left-to-right layout would work well in locales where users read left-to-right. Such would provide a comfortable, intuitive experience. Similarly, in a right-to-left layout, selected controls meeting certain criteria can appear to the right of other controls. A right-to-left layout would work well in locales where users read right-to-left. Such would provide a comfortable, intuitive experience for these users. Any suitable type of criteria can be utilized to determine how to distribute the selected controls along the single line. Distributing selected controls along a single line makes efficient use of both horizontal and vertical screen real estate. Specifically, in a horizontal dimension, having selected controls distributed along a single line facilitates quick visual identification of controls that are, in at least some embodiments, most often used. This enables screen real estate in the vertical dimension to be utilized for other controls that might, for example, be used less often.

In at least some embodiments, at least some of the controls that appear distributed along the single line are controls that are related to navigation of some type. For example, such controls can include, by way of example and not limitation, back and forward navigation buttons, a navigation control that provides an input field, such as an address bar or search bar, and/or input instrumentalities that enable a user to switch between views of different content, such as tabs.

In addition, in at least some embodiments, a control set can be visually treated within the web browser user interface in a manner that places greater emphasis on site content rather than controls.

In at least some embodiments, a web browser user interface is designed to enable site branding and functionality. Specifically, websites can provide content that can be utilized in a control layout area near the top of the web browser user interface to reinforce branding through the use of color and/or a site-provided icon, termed a “favicon,” that serves dual roles as a branding instrumentality and a site's home button. Further, in at least some embodiments, branding can be reinforced through the use of a site-associated color that is utilized for rendering one or more web browser navigation controls. Further, in at least some embodiments, websites do not have to provide all of the functionality of a browser. Rather, a site can provide or specify functionality that is best suited for that particular website. In this manner, the user experience is enhanced by providing a more site-focused experience with less distractions, while, at the same time, providing at least some browser controls. For example, some websites are better suited to act like applications than other websites. Yet, these websites can still benefit from at least some browser functionality. For example, a news site might utilize most of the core browser functionality, such as navigation buttons, to navigate to different parts of the site. The news site might, however, lack the ability to queue up articles in tabs. By enabling an application-like experience through the user interface that is exposed to the user, and at the same time having browser controls such as tabs available, the user experience is enhanced insofar as providing a site-centric experience with at least some browser functionality. As another example, consider a situation such as an immersive site that provides an ability to quickly look up information on the site. For example, the user could be using a web email application and receive and email from a friend to go to the movies. Instead of having to access a full web browser, the user can simply open a new tab within their web email application and perform a search without losing the context of the email application.

In the discussion that follows, a section entitled “Operating Environment” is provided and describes one environment in which one or more embodiments can be employed. Following this, a section entitled “Example Linear Control Layout Module” describes an example linear control layout module in accordance with one or more embodiments. Next, a section entitled “Visual Treatment of Controls to Emphasize Site Content” describes how controls can be visually treated to emphasize site content in accordance with one or more embodiments. Following this, a section entitled “Placing Visual Emphasis on Certain Controls that Appear in the Control Layout Area” describes how visual emphasis can be placed on certain controls in accordance with one or more embodiments. Next, a section entitled “Sizing the Address Bar Relative to the Tab Band” describes how an address bar can be sized and re-sized relative to a tab band in accordance with one or more embodiments. Next, a section entitled “Branded Browser Frame” describes how a web browser user interface can be branded in accordance with one or more embodiments. Following this, a section entitled “Example Method” describes an example method in accordance with one or more embodiments. Last, a section entitled “Example System” describes an example system in accordance with one or more embodiments.

Operating Environment

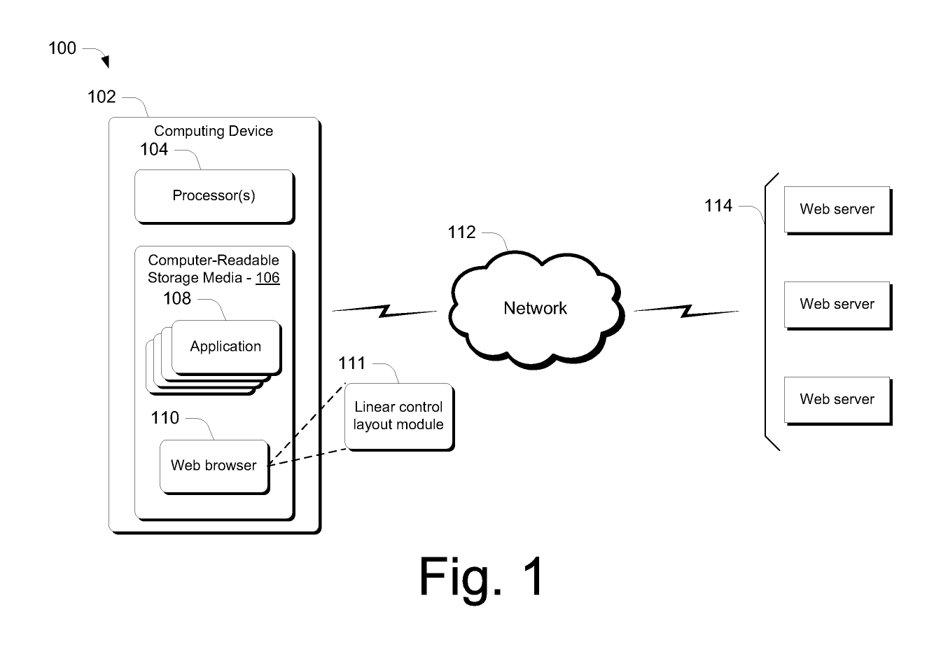

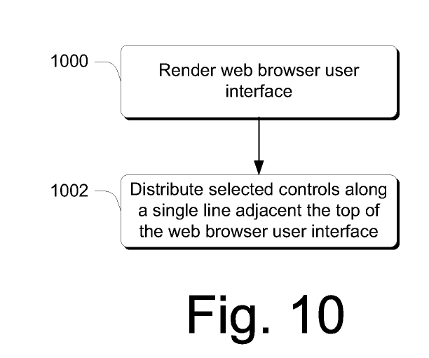

FIG. 1 illustrates an operating environment in accordance with one or more embodiments, generally at 100. Environment 100 includes a computing device 102 having one or more processors 104, one or more computer-readable storage media 106 and one or more applications 108 that reside on the computer-readable storage media and which are executable by the processor(s). The computer-readable storage media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 10.

In addition, computing device 102 includes a software application in the form of a web browser 110 that includes or otherwise makes use of a linear control layout module 111 to provide a web browser user interface that operates as described above and below. The linear control layout module is designed to assist users in focusing on a website's content, while removing some of the distractions that can be provided by controls. For example, the web browser user interface, via the linear control layout module, can include a subset of selected controls distributed along a single line at the top of the web browser user interface. Layout of the controls can be in a left-to-right or a right-to-left fashion, as noted above. Any suitable type of criteria can be utilized to determine how to distribute the selected controls along the single line. For example, one criterion can include the frequency of use of a particular control across a collection of users. Alternately or additionally, another criterion can include an individual user's preference such that the appearance of the controls along the single line is user-customizable. Further, in at least some embodiments, at least some of the controls that appear distributed along the single line are controls that are related to navigation of some type. For example, such controls can include, by way of example and not limitation, back and forward navigation buttons, a navigation control that provides an input field, such as an address bar or search bar, and/or input instrumentalities that enable a user to switch between views of different content, such as tabs.

In addition, in at least some embodiments, a control set can be visually treated within the web browser user interface in a manner that places greater emphasis on site content rather than controls, as will become apparent below.

Further, in at least some embodiments, the linear control layout module is designed to enable websites to brand one or more web browser controls to reinforce the website's association and provide a brand-integrated user experience, as described above and below.

In addition, environment 100 includes a network 112, such as the Internet, and one or more web servers 114 from and to which content can be received and sent, as described above and below. Such content can include web pages that are received from the web servers.

Computing device 102 can be embodied as any suitable computing device such as, by way of example and not limitation, a desktop computer, a portable computer, a handheld computer such as a personal digital assistant (PDA), cell phone, and the like.

Having described an example operating environment, consider now a discussion of some example embodiments that can utilize linear control layout module 111.

Example Linear Control Layout Module

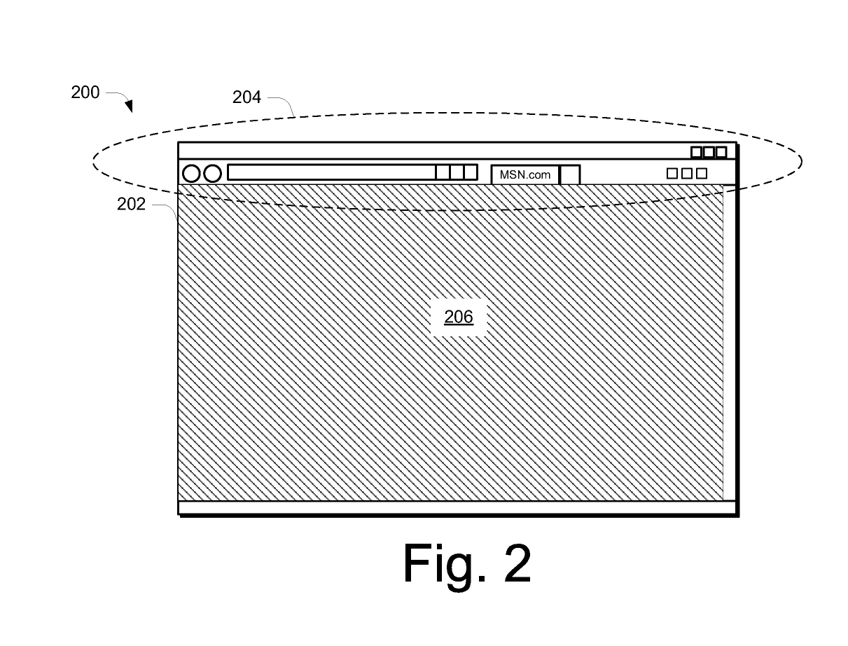

FIG. 2 illustrates an example web browser generally at 200 in accordance with one or more embodiments. In this particular example, web browser 200 includes a web browser user interface 202 which, in turn, includes a control layout area 204 adjacent and above a content rendering area 206.

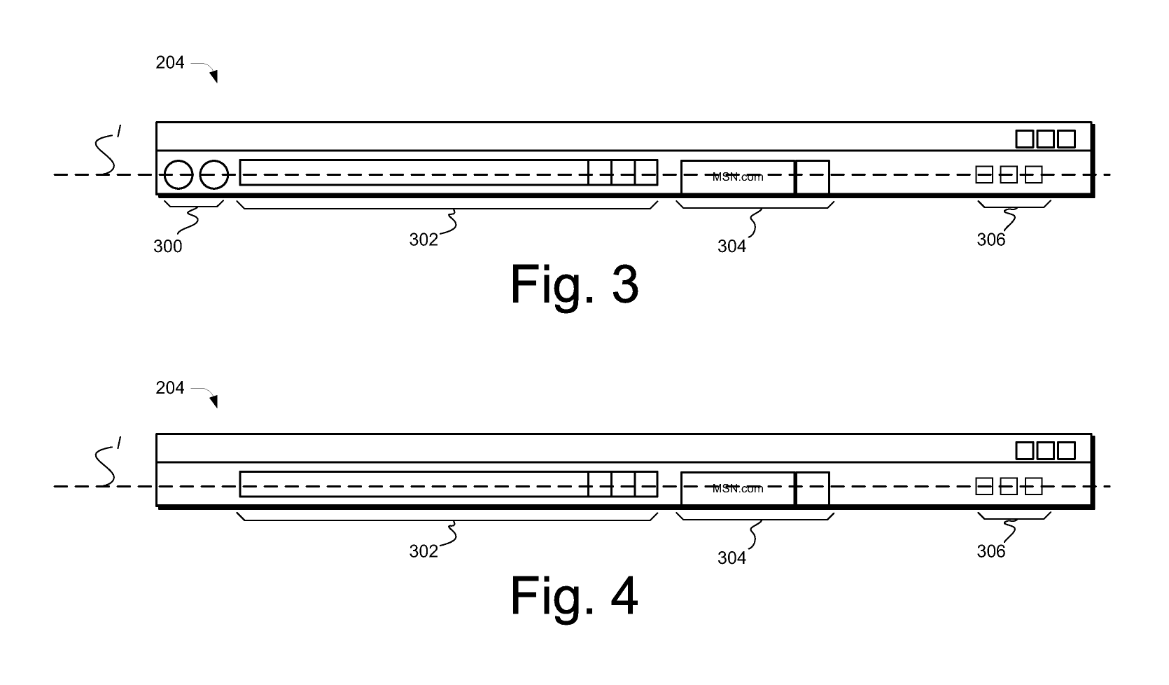

The control layout area 204 is provided under the influence of the linear control layout module 111 (FIG. 1). The control layout area 204 is designed to assist users in focusing on a website's content, such as that rendered within content rendering area 206, while removing some of the distractions that can be provided by controls. For example, the web browser user interface, via the linear control layout module, can include a subset of selected controls distributed along a single line at the top of the web browser user interface. Such is shown in FIG. 3 in more detail.

FIG. 3 illustrates control layout area 204 in more detail, in accordance with one or more embodiments. In this example, a plurality of controls is distributed along a single line designated “l”. As noted above, layout of the controls can be in a left-to-right or a right-to-left fashion. Any suitable type of criteria can be utilized to determine how to distribute the selected controls along the single line, examples of which are provided above. In one or more embodiments, control groupings can be based on relationships that the controls have with one another, as will become apparent below. For example, in at least some embodiments, at least some of the controls that appear distributed along the single line are controls that are related to navigation of some type. For example, such controls can include, by way of example and not limitation, back and forward navigation buttons 300, a navigation control 302 that provides an input field for receiving or presenting text, such as an address bar or search bar, and/or input instrumentalities that enable a user to switch between views of different content, such as tabs 304.

In the illustrated and described example, it can be desirable to group the back and forward navigation buttons together because each is related to navigation. Further, in at least some embodiments, it can be desirable to group an address bar such as that represented by navigation control 302, adjacent the back and forward buttons. This is because the address bar and back/forward buttons are related insofar as the address bar shows URLs to which the browser has been navigated, in some instances, via the back and forward buttons.

In addition, other controls can be distributed along a line/such as so-called secondary controls 306. From a visual standpoint then, line/defines, in at least some embodiments, a continuum of controls that are distributed in terms of controls that meet some criterion or criteria, to controls that meet, to a lesser degree (or not at all) the criterion or criteria. In at least some embodiments, line l is disposed at the top of the web browser user interface (FIG. 2) and includes at least some navigation controls above which no other navigation controls appear. In yet other embodiments, line l is disposed at the top of the web browser user interface and includes a tab band containing one or more tabs above which no other navigation controls appear.

FIG. 4 illustrates control layout area 204 in accordance with another embodiment. Like numerals from the FIG. 3 embodiment have been utilized to depict like components. In this example, control layout area 204 includes a navigation control 302 that provides an input field, such as an address bar or search bar, and input instrumentalities that enable a user to switch between views of different content, such as tabs 304 distributed a long line l.

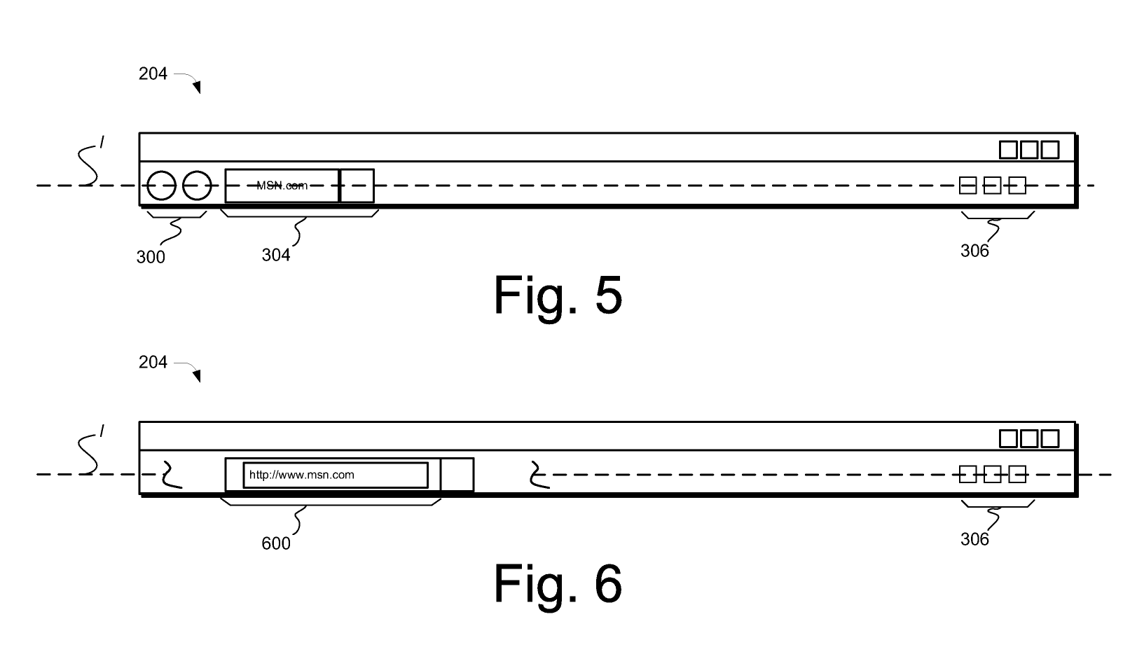

FIG. 5 illustrates control layout area 204 in accordance with another embodiment. Like numerals from the FIG. 3 embodiment have been utilized to depict like components. In this example, control layout area 204 includes back and forward navigation buttons 300 and input instrumentalities that enable a user to switch between views of different content, such as tabs 304 distributed a long line l.

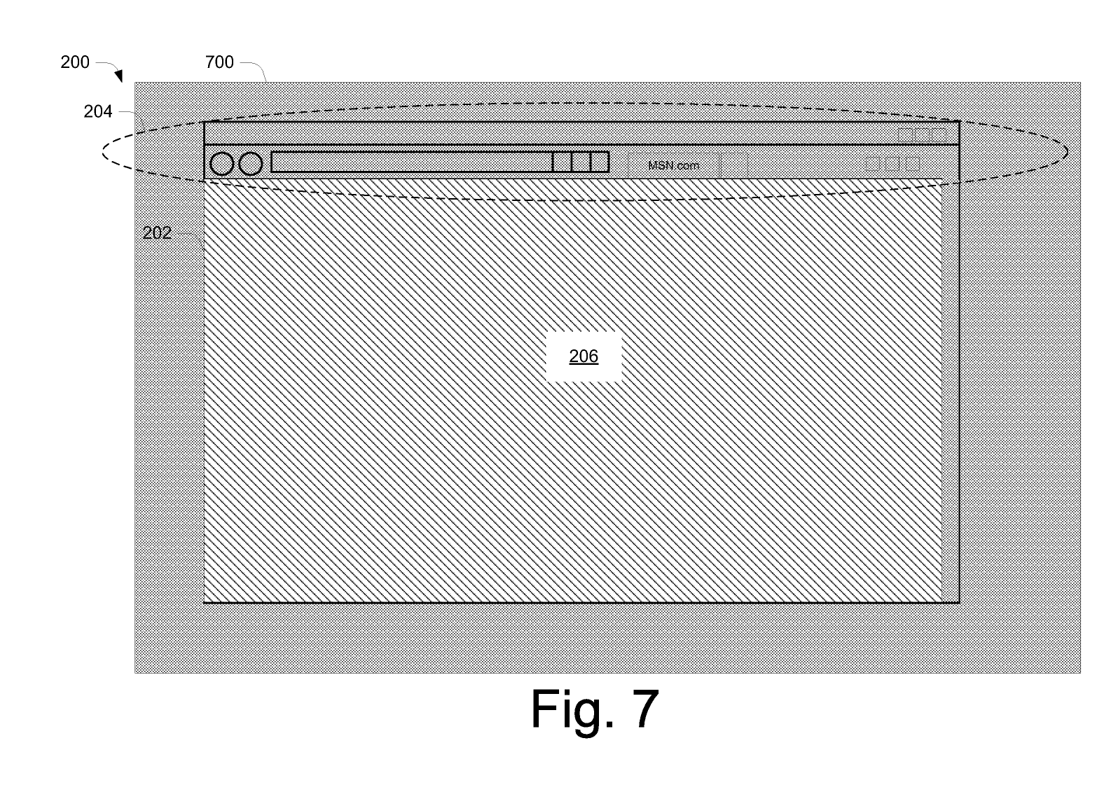

FIG. 6 illustrates control layout area 204 in accordance with another embodiment. Like numerals from the FIG. 3 embodiment have been utilized to depict like components. In this example, control layout area 204 includes a tab 600 within which an address bar appears. Line l has been broken for clarity. In this example, having the address bar included within the tab can reduce facilitates clarity and visual identification of a current location. Specifically, having this shared information appear in one control provides one clear address of the location to which the user has navigated. To switch and navigate locations takes less steps and utilizes less cognitive load.

Visual Treatment of Controls to Emphasize Site Content

In addition, in at least some embodiments, a control set can be visually treated within the web browser user interface in a manner that places greater emphasis on site content rather than the controls, as will become apparent below.

As an example, consider FIG. 7 where like numerals from the FIG. 2 embodiment are utilized to depict like components. There, an example web browser 200 is shown in accordance with one or more embodiments. In this particular example, web browser 200 includes a web browser user interface 202 which, in turn, includes a control layout area 204 and a content rendering area 206.

As in the above example, the control layout area 204 is provided under the influence of the linear control layout module 111 (FIG. 1). The control layout area 204 is designed to assist users in focusing on a website's content, such as that rendered within content rendering area 206, while removing some of the distractions that can be provided by controls. For example, the web browser user interface, via the linear control layout module, can include a subset of selected controls distributed along a single line at the top of the web browser user interface. Further, in this example, the web browser user interface is shown rendered against a client desktop 700 which includes a theme represented by the gray dotted pattern. Any suitable themes can be used.

In the illustrated and described embodiment, in order to place greater visual emphasis on content that is rendered within content rendering area 206, control layout area 204 can be rendered to effectively be clear so as to reflect the underlying theme. Specifically, in this example, notice that the controls that appear in the content rendering area reflect the underlying theme as indicated by the gray dotted pattern. In at least some embodiments, when a user selects a particular control that appears within the control layout area 204, the control can assume a different color which can facilitate the discovery of controls that appear in the control area 204.

Alternately or additionally, the controls that appear within the control layout area 204 can be rendered in a monochromatic manner in which the controls and the associated control layout area in which they appear can be rendered in a single color that is selected to emphasize content that appears in content rendering area 206. For example, the controls and the control layout area 204 can be rendered in grayscale to place emphasis on content rendering area 206. Upon selection of a control by a user, the control may assume a different color to place emphasis thereon.

Placing Visual Emphasis on Certain Controls that Appear in the Control Layout Area

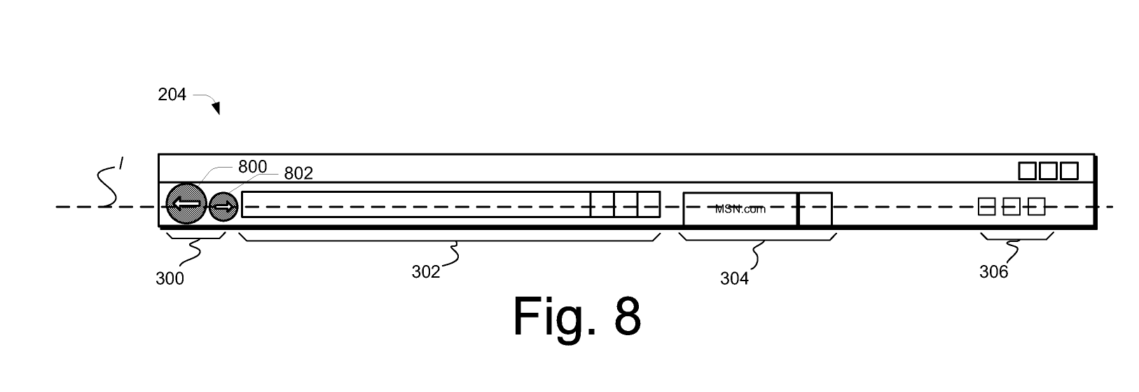

In at least some embodiments, visual emphasis can be placed on certain controls that appear in the control layout area. As an example, consider FIG. 8 which illustrates the control layout area 204 of the FIG. 3 example, in accordance with an alternate embodiment. Like numerals from the FIG. 3 example are utilized to depict like components.

In this example, as in the above example, a plurality of controls are distributed along a single line designated “l”. The example controls can include, by way of example and not limitation, back and forward navigation buttons 300, a navigation control 302 that provides an input field, such as an address bar or search bar, and/or input instrumentalities that enable a user to switch between views of different content, such as tabs 304.

Notice in this example that backward navigation button 800 appears larger than forward navigation button 802. In this example, button 800 is larger because it is used more often than forward navigation button 802. Other techniques of visual emphasis can be used without departing from the spirit and scope of the claimed subject matter.

Sizing the Address Bar Relative to the Tab Band

As display screen sizes get horizontally larger, there is a trend toward providing a widescreen user experience. To be sure, part of the motivation of at least some of the above-described embodiments is associated with providing an improved user experience by efficiently using horizontally available screen real estate.

In at least some embodiments, the web browser is designed in a manner to efficiently manage the controls in the control layout area when the web browser window is resized. For example, the web browser can ascertain the horizontal resolution of the display screen and, responsive to a window re-size operation, can intelligently manage the layout of the tabs and address bar.

For example, the web browser can select a ratio between the size of the tab band that contains the tabs and the address bar. The ratio can change in conjunction with changes in the horizontal resolution of the display screen. Further, once the ratio is selected between the tab band and the address bar, the web browser can attempt to maintain this ratio when the web browser window is resized, e.g., made smaller. However, at some threshold level when the size of the web browser window is reduced, the web browser can switch to a reduced address bar width and can begin removing controls, such as secondary controls. The dimensions of the reduced width of the address bar can be selected to maintain a desired amount of text therewithin. As the size of the window continues to be reduced, the web browser can begin to remove tabs so that the address bar and the navigation controls are viewable even on a very small screen size.

Consider now an embodiment in which the browser's frame can be branded to reinforce a website's association in accordance with one or more embodiments.

Branded Browser Frame

As noted above, in at least some embodiments, a web browser user interface is designed to enable site branding and functionality. Specifically, websites can provide content that can be utilized in the control layout area near the top of the web browser user interface (a portion of which constitutes the browser's so-called “frame”) to reinforce branding through the use of color and/or a site-provided icon, termed a “favicon,” that serves dual roles as a branding instrumentality and a site's home button. Content can be provided by the website in any suitable way. For example, in at least some embodiments, such content can be provided by the website through a so-called “pinning” process in which a website becomes pinned to a desktop's taskbar. Of course, it is to be appreciated and understood, that content provided by the website can be provided independent of the pinning process. For example, the content can be provided if a desktop shortcut is created and/or adding a website to the desktop's start menu.

A website can become pinned to the desktop's taskbar by virtue of a user action, such as a drag and drop operation, in which a user drags a website's icon from the browser's address bar and drops it onto their taskbar. Doing so results in creation of a web application file on the local client that includes content that can be provided by the website. For example, such content can include, by way of example and not limitation, a start URL which is the initial page that is displayed by the browser, various navigation domains that the website has specified, a web application title, and a site-provided icon termed a “favicon.” The favicon appears on the taskbar and, when clicked, causes instantiation of a browser and navigation to the initial page associated with the start URL. In a similar fashion, if the website has been added to the desktop, the favicon will appear on the desktop. Alternately or additionally, if added to the start menu or application menu, the favicon will be displayed there.

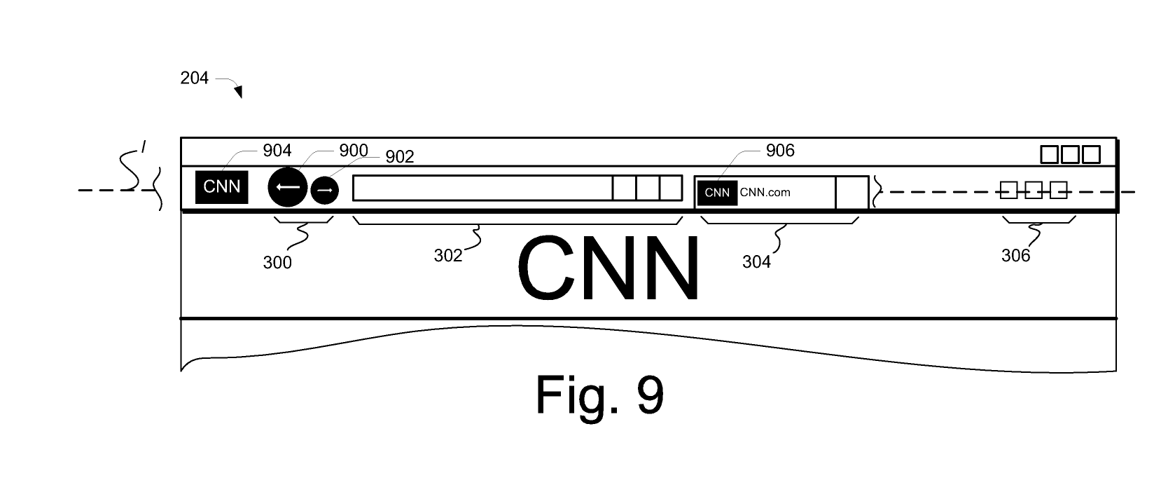

As an example, consider FIG. 9 which illustrates the control layout area 204 of the FIG. 3 example, in accordance with an alternate embodiment. Like numerals from the FIG. 3 example are utilized to depict like components.

In this example, as in the above example, a plurality of controls is distributed along a single line designated “l”. The example controls can include, by way of example and not limitation, back and forward navigation buttons 300, a navigation control 302 that provides an input field, such as an address bar or search bar, and/or input instrumentalities that enable a user to switch between views of different content, such as tabs 304. In this example, a control 904 is provided and includes content associated with the website—here the website's title “CNN” and/or a favicon. In addition, control 904 is branded with the primary color of the website's favicon. The color that is utilized to brand control 904 can be ascertained in any suitable way. For example, in at least some embodiments, the color can be ascertained by determining the most prominent color that appears in a website's favicon. Alternately or additionally, the color can be specified by the website developer and listed in the web application file stored on the client device.

In at least some embodiments, control 904 serves a dual role, both as a branding mechanism and as a website's homepage button. Specifically, if a user navigates deep into a particular website, they can return immediately to the site's homepage by clicking on the control 904.

Notice also in this example that backward navigation button 900 appears larger than forward navigation button 902. In this example, button 900 is larger because it is used more often than forward navigation button 902. Notice also, in this embodiment, that site branding is reinforced by rendering control 900, 902 in the color that is used to brand control 904.

Notice also, that in at least some embodiments, branding is further reinforced through the use of a website icon 906 that appears in tab 304.

In at least some embodiments, navigation buttons 900, 902, as well as other controls, can utilize a site-associated color to depict active and inactive states. Specifically, the site-associated color can be utilized when a control, such as navigation buttons 900, 902, are both active and inactive. In the inactive state, in addition to the site-associated color, other colors can be utilized to depict the inactive state. For example, in the instant example, the white arrow that appears in forward button 902 might be rendered in grayscale when the button is inactive.

In at least some embodiments, individual websites can be customized based on customization parameters that can be specified by the site's web developer and/or by an end user. For example, for a news site, a favorites bar may be desirable to enable stories to be “clipped” and saved. On the other hand, for an email application that has its own notion of “flagging”, the favorites bar would be duplicative and hence, unnecessary.

In operation, as a user navigates through a site's content, the web browser's branded frame, including the branded controls, reminds the user of the content's affiliation with the website.

It is to be appreciated and understood that various features of the above-described embodiments can be utilized with any of the other described features, even though the features may not appear together in the same drawing.

Example Method

FIG. 10 is a flow diagram that describes steps a method in accordance with one or more embodiments. The method can be implemented in connection with any suitable hardware, software, firmware, or combination thereof. In at least some embodiments, the method can be implemented in software in the form of a web browser and/or a linear control layout module, such as the one described above.

Step 1000 renders a web browser user interface. Step 1002 distributes selected controls along a single line adjacent the top of the web browser user interface. Examples of selected controls are provided above.

Example System

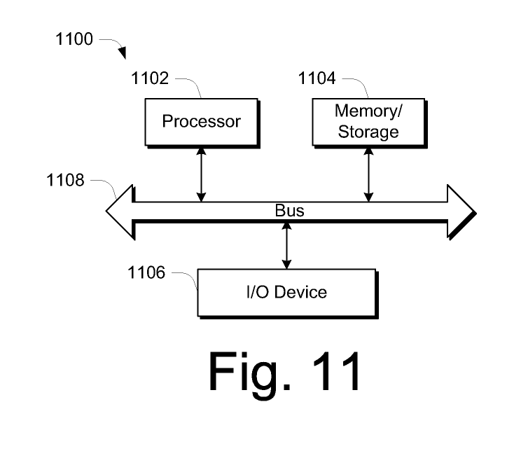

FIG. 11 illustrates an example computing device 1100 that can be used to implement the various embodiments described above. Computing device 1100 can be, for example, computing device 102 or web server 114 of FIG. 1.

Computing device 1100 includes one or more processors or processing units 1102, one or more memory and/or storage components 1104, one or more input/output (I/O) devices 1106, and a bus 1108 that allows the various components and devices to communicate with one another. Bus 1108 represents one or more of any of several types of bus structures, including a memory bus or memory controller, a peripheral bus, an accelerated graphics port, and a processor or local bus using any of a variety of bus architectures. Bus 1108 can include wired and/or wireless buses.

Memory/storage component 1104 represents one or more computer storage media. Component 1104 can include volatile media (such as random access memory (RAM)) and/or nonvolatile media (such as read only memory (ROM), Flash memory, optical disks, magnetic disks, and so forth). Component 1104 can include fixed media (e.g., RAM, ROM, a fixed hard drive, etc.) as well as removable media (e.g., a Flash memory drive, a removable hard drive, an optical disk, and so forth).

One or more input/output devices 1106 allow a user to enter commands and information to computing device 1100, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer-readable storage media”.

“Computer-readable storage media” include volatile and non-volatile, removable and non-removable media implemented in any method or technology for storage of information such as computer readable instructions, data structures, program modules, or other data. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

In various embodiments, a web browser user interface includes a subset of selected controls distributed along a single line at the top of the web browser user interface. Layouts of the controls can be in a left-to-right or a right-to-left fashion. Specifically, in a left-to-right layout, selected controls meeting certain criteria can appear to the left of other controls. Similarly, in a right-to-left layout, selected controls meeting certain criteria can appear to the right of other controls. In at least some embodiments, at least some of the controls that appear distributed along the single line are controls that are related to navigation of some type. Such controls can include those that enable textual input to be provided by user.

In at least some embodiments, a web browser user interface is designed to enable site branding and functionality. Specifically, websites can provide content that can be utilized in a control layout area near the top of the web browser user interface to reinforce branding through the use of color and/or a site-provided icon, termed a “favicon” that serves dual roles as a branding instrumentality and a site's home button. Further, in at least some embodiments, branding can be reinforced through the use of a site-associated color that is utilized for rendering one or more web browser navigation controls.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer-readable storage media embodying computer-readable instructions which, when executed, implement a web browser comprising:
a web browser user interface;
a content rendering area within the web browser user interface; and
a control layout area adjacent and above the content rendering area,
wherein the control layout area includes a subset of selected controls distributed along a single line at the top of the web browser user interface,
wherein one of the selected controls comprises a website-branded control that serves as a website's homepage button, and a navigation control that provides an input field.

2. The one or more computer readable storage media of claim 1, wherein said navigation control comprises an address bar.

3. The one or more computer readable storage media of claim 1, wherein said navigation control comprises a search bar.

4. The one or more computer readable storage media of claim 1, wherein said selected controls further comprise one or more tabs.

5. The one or more computer readable storage media of claim 1, wherein the web browser user interface includes no other navigation controls that appear above the selected controls that are distributed along the single line.

6. One or more computer-readable storage media embodying computer-readable instructions which, when executed, implement a web browser comprising:
a web browser user interface;
a content rendering area within the web browser user interface; and
a control layout area adjacent and above the content rendering area,
wherein the control layout area includes a subset of selected controls distributed along a single line at the top of the web browser user interface,
wherein the selected controls comprise: a website color-branded control that serves as a website's homepage button, back and forward website color-branded navigation buttons, a navigation control that provides an input field, and an input instrumentality that enables a user to switch between views of different content.

7. The one or more computer readable storage media of claim 6, wherein the navigation control that provides an input field comprises an address bar.

8. The one or more computer readable storage media of claim 6, wherein the navigation control that provides an input field comprises an address bar, wherein the input instrumentality that enables a user to switch between views of different content comprises one or more tabs.

9. The one or more computer readable storage media of claim 6, wherein the navigation control that provides an input field comprises an address bar, wherein the input instrumentality that enables a user to switch between views of different content comprises one or more tabs, and wherein one of said one or more tabs is configured to include a color-branded website icon.

10. The one or more computer readable storage media of claim 6, wherein at least some of the selected controls are configured to use a website-associated color to depict active and inactive states.

11. The one or more computer readable storage media of claim 6, wherein the input instrumentality that enables a user to switch between views of different content comprises one or more tabs at least one of which is configured to include a color-branded website icon.

12. The one or more computer readable storage media of claim 6, wherein the web browser user interface includes no other navigation controls that appear above the selected controls that are distributed along the single line.

13. The one or more computer readable storage media of claim 6, wherein the selected controls are distributed along the single line in a left-to-right fashion as recited.

14. The one or more computer readable storage media of claim 6, wherein at least some of the selected controls are distributed along a single line in accordance with their associated frequency of use across a collection of users.

15. The one or more computer readable storage media of claim 6, wherein appearance of at least some controls along the single line is user-customizable.

16. The one or more computer readable storage media of claim 6, wherein control groupings of at least some controls that appear along the single line are based on relationships between said at least some controls.

17. The one or more computer readable storage media of claim 6, wherein the control layout area is configured to reflect an underlying desk top theme.

18. The one or more computer readable storage media of claim 6, wherein at least some of the selected controls are configured to assume different colors based on use.

19. One or more computer-readable storage media embodying computer-readable instructions which, when executed, implement a web browser comprising:
a web browser user interface;
a content rendering area within the web browser user interface; and
a control layout area adjacent and above the content rendering area,
wherein the control layout area includes a subset of selected controls distributed along a single line at the top of the web browser user interface,
wherein the selected controls comprise: a website color-branded control that serves as a website's homepage button, back and forward color-branded navigation buttons adjacent and to the right of the website color-branded control, and at least a tab band configured to expose a plurality of tabs to the right of the back and forward color-branded navigation buttons;
wherein the web browser user interface includes no navigation controls that appear above the selected controls that are distributed along the single line.

20. The one or more computer readable storage media of claim 19, wherein the control layout area includes at least one other navigation control distributed along the single line to the right of the website color-branded control.
